(19) United States
(12) Patent Application Publication
(10) Pub. No.: US 2008/0200058 A1
(43) Pub. Date: Aug. 21, 2008

(54) POSITIONING HOOKS AND PLUG CONNECTOR HAVING POSITIONING HOOKS

(76) Inventor: Wen-Hsien TSAI, Hsin-Tien City (TW)

Correspondence Address: Hershkovitz & Associates, LLC, 2845 Duke Street, Alexandria, VA, 22314, US

(21) Appl. No.: 12/026,183

(22) Filed: Feb. 5, 2008

(30) Foreign Application Priority Data
Feb. 15, 2007 (TW) 096203071

(51) Int. Cl. H01R 13/627

(52) U.S. Cl. 439/353

(57) ABSTRACT

A plug connector is engaged detachably with a socket connector having a shell and two positioning holes defined through the shell. The plug connector has an insulative housing, a plurality of terminals, a shell and a pair of positioning hooks. The insulative housing has a pair of mounting blocks. The terminals are mounted in the insulative housing. The positioning hooks are mounted respectively through the mounting blocks and each positioning hook has a root, a hooking arm and a fastening arm, the hooking arm mounted through one mounting block and has a hook portion formed on the hooking arm and hooking one positioning hole of the shell of the socket connector. With the positioning hooks, the plug connector is engaged securely with the socket connector without inadvertently falling off.

### BACKGROUND OF THE INVENTION

1. Field of the Invention

The present invention relates to a connector, and more particularly to a plug connector that has a pair of positioning hooks detachably hooking on a socket connector. The positioning hooks have a sufficient tensile strength to prevent ruptures and tears after times of detaching the plug connector from the socket connector by pulling the positioning hooks out of the socket connector.

2. Description of Related Art

The newly developed Mini Universal Serial Bus (Mini-USB) interfaces are used popularly in lots of portable electronic devices such as cellular phones, card readers, digital cameras, audio players, flash drive devices, etc. Such portable electronic devices integrated with the Mini-USB interfaces allow the data to be directly transmitted with one another under the USB On The GO (OTG) protocol without an intervening computer.

U.S. Pat. No. 6,976,870 discloses a conventional USB connector having a shell. The shell has a plurality of fastening members formed on the shell by a stamping process and holding the mating connector.

U.S. Pat. No. 7,128,608 discloses a conventional USB socket connector having a shell. The shell has a plurality of resilient positioning members formed on the shell and holding a plug connector.

However, the aforementioned fastening members and resilient positioning members cannot provide sufficient positioning forces to prevent connectors from being disconnected inadvertently from each other when the fastening members and the resilient positioning members are sized smaller in mini connectors such as Micro-USB connectors being smaller than Mini-USB connectors.

To overcome the shortcomings, the present invention provides a plug connector having positioning hooks to mitigate or obviate the aforementioned problems.

### SUMMARY OF THE INVENTION

The main objective of the invention is to provide a plug connector that has a pair of positioning hooks detachably hooking on a socket connector. The positioning hooks have a sufficient tensile strength to prevent ruptures and tears after times of detaching the plug connector from the socket connector by pulling the positioning hooks out of the socket connector.

A plug connector in accordance with the present invention detachably is engaged with a socket connector having a shell and two positioning holes defined through the shell. The plug connector comprises an insulative housing, a plurality of terminals, a shell and a pair of positioning hooks. The insulative housing has a pair of mounting blocks. The terminals are mounted in the insulative housing. The positioning hooks are mounted respectively through the mounting blocks and each positioning hook has a root, a hooking arm and a fastening arm. The hooking arm mounted through one mounting block and has a hook portion formed on the hooking arm and hooking one positioning hole of the shell of the socket connector. With the positioning hooks, the plug connector securely is engaged with the socket connector without inadvertently falling.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a plug connector in accordance with the present invention;

FIG. 2 is a perspective view of positioning hooks of the plug connector in FIG. 1 in accordance with the present invention;

FIG. 3A is a cross sectional perspective view of the plug connector in FIG. 1;

FIG. 3B is a cross sectional side view of the plug connector in FIG. 3A;

FIG. 4A is an operational perspective view of the plug connector in FIG. 1 engaged with a socket connector; and

FIG. 4B is an operational cross sectional side view of the plug connector in FIG. 4A engaged with the socket connector.

### DETAILED DESCRIPTION OF THE PREFERRED EMBODIMENT

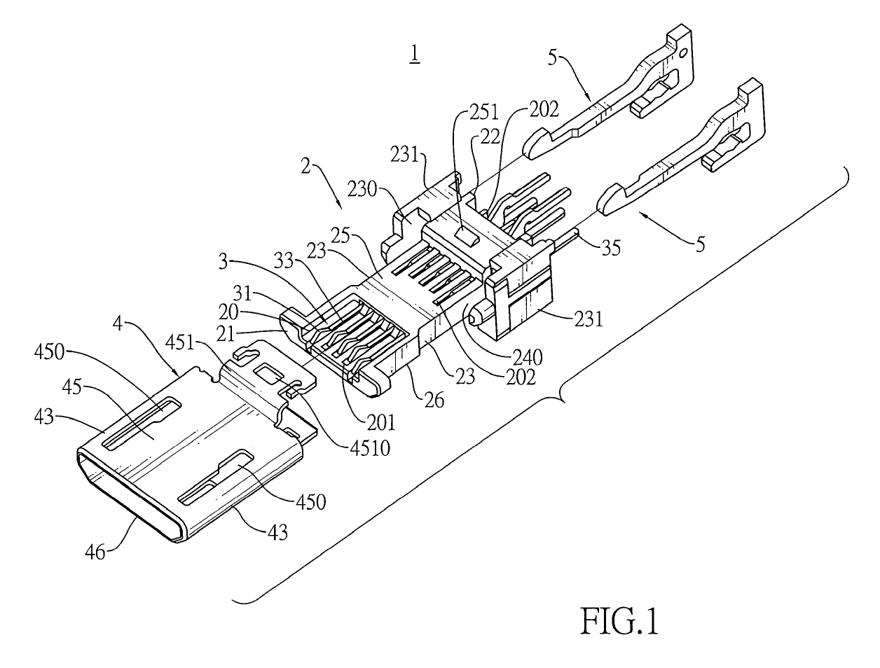

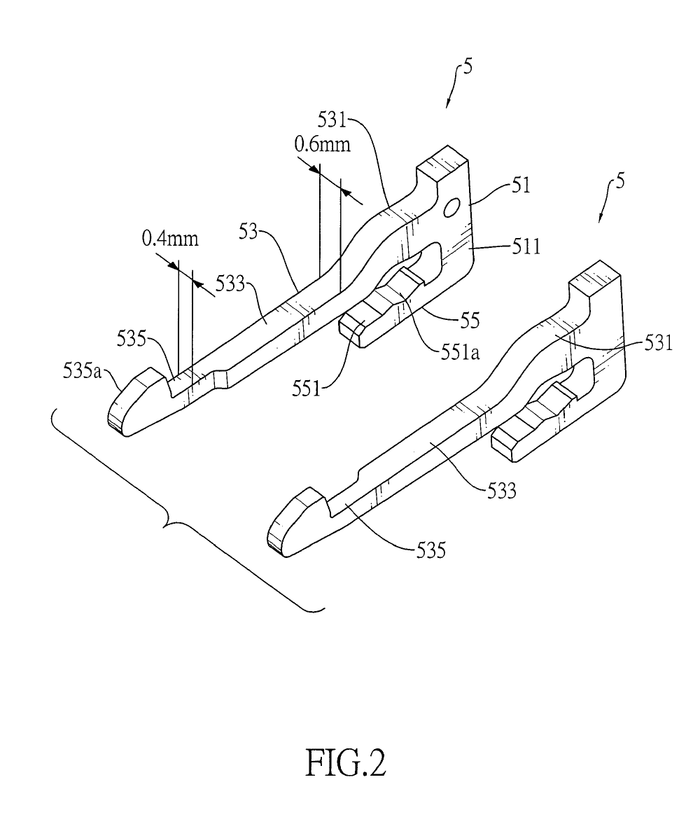

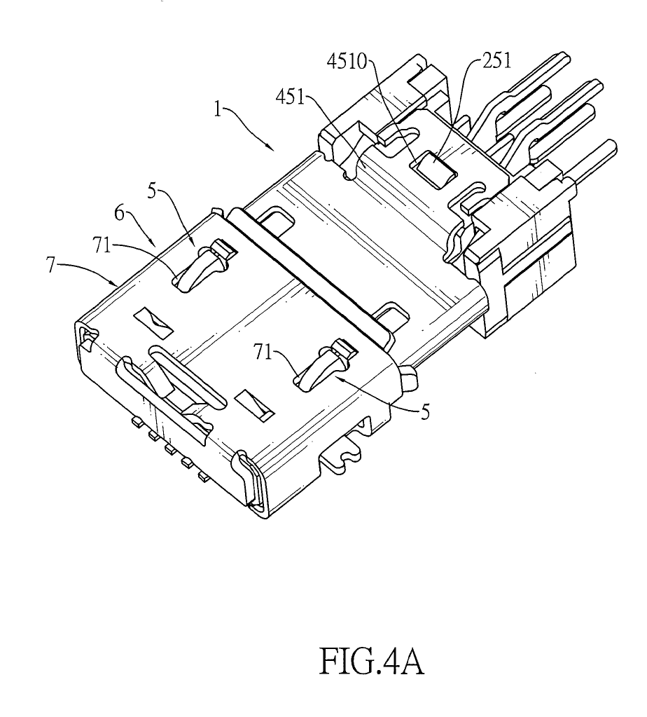

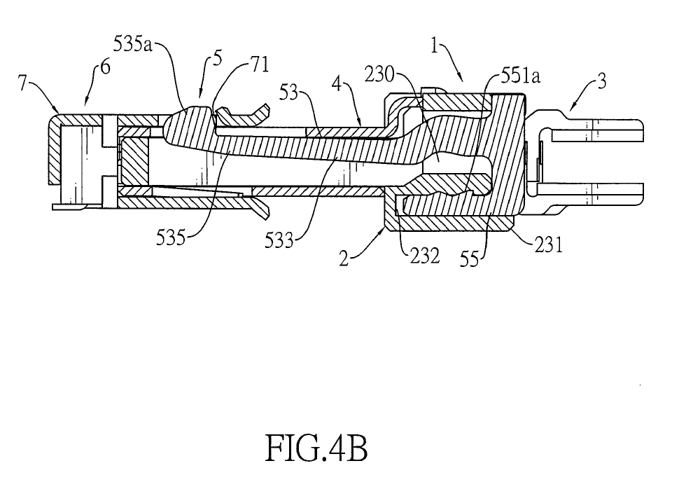

With reference to FIGS. 1, 2 and 4A, 4B, a plug connector (1) in accordance with the present invention is a Micro-Universal Serial Bus (Micro-USB) plug connector being smaller than and substituting for Mini-USB connectors. The plug connector (1) is engaged detachably with a socket connector (6). The socket connector (6) is a Micro-USB socket connector and has a shell (7). The shell (7) is hollow and has a top and a pair of positioning holes (71) defined through the top.

The plug connector (1) comprises an insulative housing (2), a plurality of terminals (3), a shell (4) and a pair of positioning hooks (5).

The insulative housing (2) has a front end (21), a rear end (22), two opposite surfaces (23), a top (25), a bottom (26), a recess (20), a plurality of grooves (201), a plurality of passageways (202) and a pair of mounting blocks (231) and may further have a mounting protrusion (251).

The recess (20) is defined in the front end (21) and the top (25) and has a inner bottom surface.

The grooves (201) are defined longitudinally in the inner bottom surface of the recess (20) in a transverse row.

The passageways (202) are defined longitudinally in the insulative housing (2) through the rear end (22) and correspond respectively to and communicate with the grooves (201).

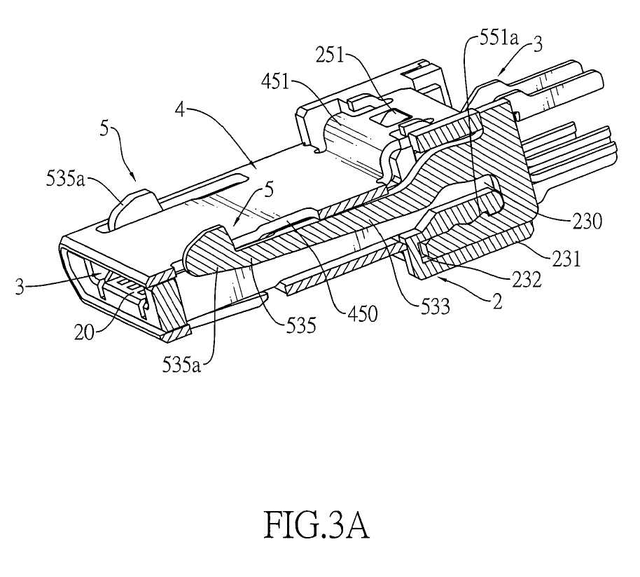

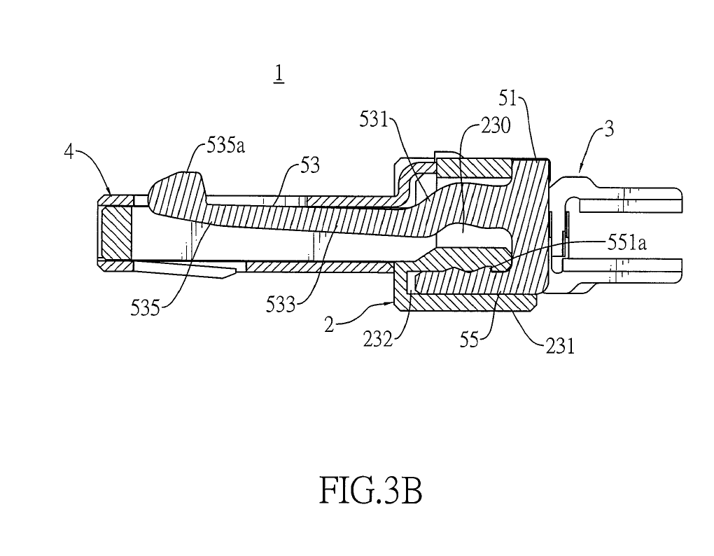

With further reference to FIGS. 3A and 3B, the mounting blocks (231) are formed on and transversely protrude respectively from the sides (23) adjacent to the rear end (22) of the insulative housing (2). Each mounting block (231) has a front end, a rear end, a channel (230) and a mounting hole (232). The channel (230) is defined longitudinally through the mounting block (231). The mounting hole (232) is substantially a blind hole, is defined longitudinally in the rear end of the mounting block (231) and has an inner surface.

The mounting protrusion (251) is formed on and protrudes from the top (25) near the rear end (22) of the insulative housing (2) between the mounting blocks (231).

The terminals (3) are made of metal, are mounted respectively through the passageways (202), are mounted respectively in the grooves (201) in the insulative housing (2) and each terminal (3) has a contacting portion (31), a body portion (33) and a soldering portion (35).

The contacting portion (31) is mounted in and extends partially out of one of the grooves (201) of the insulative housing (2). The contacting portion (31) may contact a terminal of the socket connector (6).

The body portion (33) is formed on and longitudinally protrudes backward from the contacting portion (31), is mounted in one of the grooves (201) and is mounted through one of the passageways (202) of the insulative housing (2).

The soldering portion (35) is formed on and longitudinally protrudes backward from the body portion (33) and extends out of the rear end (22) of the insulative housing (2). The soldering portion (35) is soldered on a circuit contact of a printed circuit board (PCB) to connect the plug connector (1) on the PCB.

The shell (4) is hollow, is made of metal, is mounted around the insulative housing (20), extends from the front end (21) of the insulative housing (20) to the mounting blocks (231), covers the terminals (3) and has a through hole, a top (45), a bottom (46), an open front end, an open rear end and a pair of slots (450) and may further have a mounting tab (451).

The through hole is defined longitudinally through the shell (4) and is mounted around the insulative housing (20).

The slots (450) are defined longitudinally through the top (45) of the shell (4) in a transverse row.

The mounting tab (451) is formed on and protrudes backward from the open rear end at the top (45) of the shell (4) and has a mounting aperture (4510). The mounting aperture (4510) is defined through the mounting tab (451) and is mounted around the mounting protrusion (251) on the insulative housing (2) to prevent the shell (2) from separating inadvertently from the insulative housing (2).

The positioning hooks (5) are made of metal, may be made of stainless steel and correspond respectively to and are mounted respectively through the mounting blocks (231). Because the plug connector (1), the Micro-USB plug connector, has to takes at least 10,000 times of connection with and disconnection from the socket connector (6), the positioning hooks (5) are designed to have a durability experiencing at least 10,000 times of pulls. Each positioning hook (5) preferably has a dimension including a length of 9 mm, a height of 3 mm and a width of 0.6 mm. The positioning hook (5) under the dimension have to bear a pulling force of at least 4 Newton (N) to allow the plug connector (1) to separate from the socket connector (6) without inadvertently breaking. The positioning hook (5) made of stainless steel under the dimension has an excellent tensile strength of at least 5N. Each positioning hook (5) has a root (51), a hooking arm (53) and a fastening arm (55).

The root (51) abuts against the rear end of a corresponding mounting block (231).

The hooking arm (53) is arrow-shaped and flexible, is formed on and protrudes perpendicularly from the root (51), is mounted through the channel (230) of the corresponding mounting block (231) of the insulative housing (2), is tapered forward from the root (51) with a thickness decreasing gradually and hooks in one positioning hole (71) of the shell (7) of the socket connector (6). The hooking arm (53) has a tail portion (531), an intermediate portion (533) and a head portion (535). The tail portion (531) is formed on the root (51) and has a width that may be at most 0.6 mm. The intermediate portion (533) is formed on and protrudes longitudinally from the tail portion (531) and has a width that may be at most 0.6 mm. The head portion (535) is formed on and protrudes longitudinally from the intermediate portion (533) and has a width and a hook portion (535a). The width of the head portion (535) is smaller than those of the tail portion (531) and the intermediate portion (533) and may be at most 0.4 mm. The hook portion (535a) is arrowhead-shaped, is formed on and protrudes transversely from the head portion (535) and may hook in one of the positioning holes (71) in the shell (7) of the socket connector (6) to securely hold the plug connector (1) in the socket connector (6).

The fastening arm (55) is formed on and protrudes perpendicularly from the root (51) at an interval from the hooking arm (53), is mounted securely in the mounting hole (232) in the corresponding mounting block (231) and has an inside surface (551) and a plurality of teeth (551a). The inside surface (551) faces the hooking arm (53). The teeth (551a) are formed on the inside surface (551) and tightly press against and bite the inner surface of the mounting hole (232) of the corresponding mounting block (231) to prevent the positioning hook (5) from falling out of the corresponding mounting block (231).

The following table shows a pulling test for each of five pairs of the positioning hooks (5). Each pair of the positioning hooks (5) is pulled repeatedly for 10 times and a pulling force of each time applied to the pair of the positioning hooks (5) is recorded in the table.

| | Pair | | | | |
|---|---|---|---|---|---|
| Test Time | No. 1 | No. 2 | No. 3 | No. 4 | No. 5 |
| 1^{st} | 11.30N | 12.05N | 10.09N | 10.09N | 12.05N |
| 2^{nd} | 11.71N | 12.80N | 11.67N | 10.12N | 11.01N |
| 3^{rd} | 10.78N | 10.37N | 11.73N | 11.34N | 10.38N |
| 4^{th} | 13.02N | 11.73N | 10.87N | 12.64N | 11.65N |
| 5^{th} | 11.37N | 11.08N | 12.72N | 10.94N | 12.61N |
| 6^{th} | 12.31N | 11.54N | 13.30N | 12.58N | 10.75N |
| 7^{th} | 11.39N | 11.76N | 10.17N | 12.43N | 10.33N |
| 8^{th} | 10.28N | 13.05N | 11.09N | 11.80N | 10.64N |
| 9^{th} | 11.37N | 11.13N | 10.27N | 11.73N | 10.18N |
| 10^{th} | 11.37N | 11.09N | 10.96N | 10.91N | 10.88N |

As shown in the table, a maximum pulling force applied to the pairs of the positioning hooks (5) is 13.30N. A minimum pulling force is 10.09N. An average pulling force is 11.39N. In other words, the tensile strength of each positioning hook (5) is estimated conservatively to be at least 5.045N, which greatly exceeds the threshold limit of 4N required by the Micro-USB connector standard.

With the positioning hooks (5), the plug connector (1) is engaged securely with the socket connector (6) without inadvertently falling off. Furthermore, each positioning hook (5) has a sufficient tensile strength over 5N to bear over 10,000 times of pulls without inadvertent ruptures and tears. Therefore, the plug connector (1) is reliable and durable.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A positioning hook used in a plug connector, the positioning hook comprising:
a root;
a hooking arm formed on and protruding from the root and having
a tail portion formed on the root;
an intermediate portion formed on and protruding longitudinally from the tail portion; and
a head portion formed on and protruding longitudinally from the intermediate portion, the width of the head portion being smaller than those of the tail portion and the intermediate portion and the head portion having an arrowhead-shaped hook portion formed on and protruding transversely from the head portion; and
a fastening arm formed on and protruding from the root and having
an inside surface; and
a plurality of teeth formed on the inside surface.

2. The positioning hook as claimed in claim 1, wherein:
the width of the tail portion of the hooking arm is at most 0.6 mm; and
the width of the head portion of the hooking arm is at most 0.4 mm.

3. The positioning hook as claimed in claim 2, wherein the positioning hook is made of stainless steel.

4. The positioning hook as claimed in claim 3, wherein the hooking arm is tapered from the root with a thickness decreasing gradually.

5. A plug connector adapted to be engaged detachably with a socket connector having a shell having a pair of positioning holes, the plug connector comprising:
an insulative housing having
a front end;
a rear end;
two opposite surfaces;
a top;
a bottom;
a plurality of passageways defined longitudinally in the insulative housing; and
a pair of mounting blocks formed on and transversely protruding respectively from the sides and each mounting block having
a front end;
a rear end; and
a channel defined longitudinally through the mounting block; and
a mounting hole defined longitudinally in the rear end of the mounting block and having an inner surface;
a plurality of terminals made of metal and mounted respectively through the passageways;
a shell mounted around the insulative housing, extending from the front end of the insulative housing to the mounting blocks, covering the terminals and having
a through hole defined longitudinally through the shell and mounted around the insulative housing;
a top;
a bottom;
an open front end;
an open rear end; and
a pair of slots defined longitudinally through the top of the shell in a transverse row; and
a pair of positioning hooks corresponding respectively to and mounted respectively through the mounting blocks and each positioning hook having
a root abutting against the rear end of a corresponding mounting block of the insulative housing;
a hooking arm formed on and protruding from the root, mounted through the channel of the corresponding mounting block of the insulative base, adapted to hook in one positioning hole of the shell of the socket connector and having
a tail portion formed on the root;
an intermediate portion formed on and protruding longitudinally from the tail portion; and
a head portion on and protruding longitudinally from the intermediate portion, the width of the head portion being smaller than those of the tail portion and the intermediate portion and the head portion having an arrowhead-shaped hook portion formed on and protruding transversely from the head portion and adapted to hook in one of the positioning holes in the shell of the socket connector; and
a fastening arm formed on and protruding from the root, mounted securely in the mounting hole in the corresponding mounting block of the insulative housing and having
an inside surface facing the hooking arm; and
a plurality of teeth formed on the inside surface and tightly pressing against and biting the inner surface of the mounting hole of the corresponding mounting block of the insulative housing.

6. The plug connector as claimed in claim 5, wherein:
the width of the tail portion of the hooking arm of each positioning hook is at most 0.6 mm; and
the width of the head portion of the hooking arm of each positioning hook is at most 0.4 mm.

7. The plug connector as claimed in claim 6, wherein each positioning hook is made of stainless steel.

8. The plug connector as claimed in claim 7, wherein the hooking arm of each positioning hook is tapered forward from the root with a thickness decreasing gradually.

9. The plug connector as claimed in claim 8, wherein:
the insulative housing further has a mounting protrusion formed on and protruding from the top near the rear end of the insulative housing between the mounting blocks; and
the shell further has a mounting tab formed on and protruding backward from the rear open end at the top of the shell and having a mounting aperture defined through the mounting tab and mounted around the mounting protrusion on the insulative housing.

10. The plug connector as claimed in claim 9, wherein the plug connector is a Micro-USB plug connector.
